(19) United States
(12) Patent Application Publication
(10) Pub. No.: US 2016/0100606 A1
(43) Pub. Date: Apr. 14, 2016

(54) CHEWING GUM WITH HARD, AMORPHOUS INCLUSIONS; AND METHODS OF MAKING THEREOF

(71) Applicant: INTERCONTINENTAL GREAT BRANDS LLC, East Hanover, NJ (US)

(72) Inventors: Aurelle Bouhet, Eysins (CH); Andre Busolin, Eysins (CH); Gaelle Buffet, Eysins (CH)

(73) Assignee: INTERCONTINENTAL GREAT BRANDS LLC, EAST HANOVER, NJ (US)

(21) Appl. No.: 14/892,641

(22) PCT Filed: May 30, 2014
(86) PCT No.: PCT/US2014/040238

§ 371 Date: Nov. 20, 2015

Related U.S. Application Data
(60) Provisional application No. 61/829,516, filed on May 31, 2013.

(51) Int. Cl. A23G 4/20; A23G 4/10

(52) U.S. Cl. CPC A23G 4/20; A23G 4/10; A23V 2002/00

(57) ABSTRACT

Disclosed herein are chewing gum products containing hard, amorphous inclusions distributed throughout a chewing gum matrix. The chewing gum product provides a new chew experience with regard to flavor, aroma and texture. The blend retains the characteristic of each format, i.e. chewing gum and hard, amorphous discontinuous phase. The use of the inclusions provides an upfront and sustained flavor delivery and provides a crunch that lasts several minutes.

### BACKGROUND

Slab chewing gum is typically prepared from gum base and particulate bulk sweetener to result in a product having a uniform texture. The uniform texture remains fairly consistent throughout the chew. The uniform texture also results in slab chewing gum being visually uninteresting.

Additionally, due to the presence of the gum base ingredients, it is challenging for flavors to be fully release from a chewing gum matrix upon chewing. With slab chewing gum, it is difficult to increase the initial hit of flavor experienced by the consumer.

There remains a need in the art for slab chewing gum products having new textures, good visual impact, increased initial flavor release, and a sustained flavor delivery during the chewing process.

### SUMMARY

In one embodiment, a chewing gum product comprises a chewing gum composition matrix comprising a gum base and a sugar alcohol bulk sweetener; and a plurality of hard, amorphous inclusions distributed throughout the chewing gum composition matrix, the inclusions having a particle size of about 50 micrometer to about 2 millimeters.

In another embodiment, a method of making a chewing gum product comprises forming a chewing gum composition matrix comprising a gum base and a sugar alcohol bulk sweetener; and mixing a plurality of hard, amorphous inclusions with the chewing gum composition matrix to distribute the inclusions throughout the chewing gum composition matrix.

The above described and other features are exemplified by the following detailed description.

### BRIEF DESCRIPTION OF THE DRAWINGS

FIG. 1 is a graphically illustrates the texture and mouthfeel results of a quantitative descriptive analysis study including chewing gum products containing hard, amorphous inclusions and comparative chewing gum containing other types of inclusions.

### DETAILED DESCRIPTION

Disclosed herein are chewing gum products containing hard, amorphous inclusions as a discontinuous phase, distributed throughout a continuous phase of a chewing gum matrix. The chewing gum product provides a new chew experience with regard to flavor, aroma and texture. The blend retains the characteristic of each format, i.e. chewing gum and hard, amorphous inclusions to deliver a unique chewing experience. The use of the inclusions provides a high upfront and sustained flavor delivery and provides a smooth crunch that lasts several minutes. The inclusions, when brightly colored or colored differently from the chewing gum composition, provide an interesting visual effect not provided by traditional slab chewing gum with or without other types of added material.

“Hard, amorphous inclusions” as used herein means particles of amorphous (glassy, non-crystalline) hard confection; specifically excluding crystalline and granulated materials; and specifically excluding seamless capsules having an inner core enveloped by an outer shell made of a carbohydrate material. The hard, amorphous inclusions are prepared from a saccharide, a sugar alcohol, or a combination thereof. The hard, amorphous inclusions have a hardness similar to, or the same as, a hard boiled candy.

“Chewing gum blend” as used herein means a homogeneous mixture of a chewing gum composition and hard, amorphous inclusions distributed therein.

“Chewing gum product” as used herein means a unit piece formed from the chewing gum blend.

In an embodiment, a chewing gum product comprises a chewing gum composition matrix comprising a gum base and a sugar alcohol bulk sweetener; and a plurality of hard, amorphous inclusions distributed throughout the chewing gum composition matrix.

### Chewing Gum Composition

In general the chewing gum composition comprises a gum base and a bulk sweetener or a gum base polymer and a bulk sweetener.

The bulk sweetener of the chewing gum can be a sugar-based or sugar-free bulk sweetener, specifically sugar-free. Bulk sugar sweeteners generally include saccharides. Suitable sugar sweeteners include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

The bulk sweetener can also be a sugar-free bulk sweetener such as a sugar alcohol, also referred to as a “sugar polyol”. The sugar alcohol can be erythritol, galactitol, isomalt, a hydrogenated starch hydrolyzate, lactitol, maltitol, mannitol, polyglycitol, sorbitol, xylitol, and the like, or a combination thereof. The sugar alcohol can be in powdered or particulate form (either crystalline or amorphous) or in syrup form (also referred to as “solution”) with water. Exemplary sugar alcohol syrups include sorbitol syrup, maltitol syrup, hydrogenated starch hydrolysate syrup, polyglycitol syrup, and the like.

The amount of bulk sweetener in the chewing gum composition can be about 1 to about 85 weight percent (“wt %”) based on the total weight of the chewing gum composition, specifically about 10 to about 75 wt %, more specifically about 20 to about 65 wt %, yet more specifically about 30 to about 55 wt %, and yet more specifically about 40 to about 45 wt %.

The chewing gum composition may further comprise an additional chewing gum composition ingredient such as a flavorant, a food acid or salt thereof, a high intensity sweetener, a sensate, a flavor modulator or potentiator, a coloring agent, a functional ingredient, a humectant, an emulsifier, or a combination thereof.

Exemplary flavorants (flavor, flavoring agent) for use in the chewing gum composition can include those artificial or natural flavors known in the art, for example synthetic flavor oils, natural flavoring aromatics and/or oils, oleoresins, extracts derived from plants, leaves, flowers, fruits, and the like, or a combination thereof. Nonlimiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof. Specific flavorants are mints such as peppermint, spearmint, artificial vanilla, cinnamon derivatives, and various fruit flavors.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

The flavorant can be used in liquid or solid form. The flavorant can be used in free form or encapsulated form. When used in solid (dry) form, suitable drying means such as spray drying a flavor oil can be used. Alternatively, the flavorant can be encapsulated, absorbed onto water soluble materials by means known in the art, for example cellulose, starch, sugar, maltodextrin, gum arabic, and the like. In an embodiment, the flavorant can be used in physical forms effective to provide an initial burst of flavor or a prolonged sensation of flavor.

More than one flavorant can be used. The amount and type of flavorant can be chosen based on the targeted release profile and flavor intensity desired. The chewing gum composition generally comprises a flavorant in an amount of about 0.001 to about 5 wt % based on the total weight of the chewing gum composition, specifically about 0.01 to about 4 wt %, yet more specifically about 0.1 to about 3 wt %, and still yet more specifically about 1.0 to about 2 wt %.

Exemplary food acids or salts thereof for use in the chewing gum composition can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof. The food acid or salt thereof may be used in free form or in an encapsulated form.

The chewing gum composition may further contain a high intensity sweetener. A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof;

water-soluble sweeteners derived from naturally occurring water-soluble sweeteners, such as steviosides and stevia derived compounds such as but not limited to steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof;

protein based sweeteners such as thaumaoccous danielli, talin, or a combination thereof; and

amino acid based sweeteners.

Furthermore, the high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, or a combination thereof.

The chewing gum composition may comprise a sensate. Exemplary sensates include cooling agents, warming agents, tingling agents, effervescent agents, or a combination thereof. Cooling agents are additives that provide a cooling or refreshing effect in the mouth, in the nasal cavity, or on skin. For example, among the useful cooling agents are included menthane, menthone, ketals, menthone ketals, menthone glycerol ketals, substituted p menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p menthane, 2 mercapto cyclo decanone, hydroxycarboxylic acids with 26 carbon atoms, cyclohexanamides, menthyl acetate, menthyl salicylate, N,2,3 trimethyl 2 isopropyl butanamide (WS-23), N-ethyl-2,2-diisopropylbutanamide, N ethyl p menthane 3 carboxamide (WS-3), ethyl ester of N-[[5-methyl-2-(1-methylethyl)cyclohexyl]carbonyl]glycine (WS-5), as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference, isopulegol, menthyloxy propane diol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, N-(4-cyanomethylphenyl) p-menthanecarboxamide (G-180), Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; Menthol methyl ether, menthyl pyrrolidone carboxylate; 2,5-dimethyl-4-(1-pyrrolidinyl)-3(2H)-furanone; cyclic α-keto enamines, cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one, compounds of the formula:

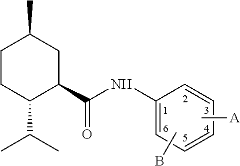

wherein B is selected from H, CH₃, C₂H₅, OCH₃, OC₂H₅; and OH; and wherein A is a moiety of the formula-CO-D, wherein D is selected from the following moieties: (i)-NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five- or six-membered heterocyclic ring; (ii)-NHCH₂COOCH₂CH₃, —NHCH₂CONH₂, —NHCH₂CH₂OCH₃, —NHCH₂CH₂OH, —NHCH₂CH(OH)CH₂OH and (iii) a moiety selected from the group consisting of:

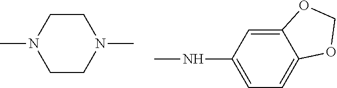

as disclosed in PCT Patent Application WO2006/125334 to Bell et al. which is incorporated in its entirety herein by reference, among others; or a combination thereof. Other compounds include the alpha-keto enamines disclosed in U.S. Pat. No. 6,592,884 to Hofmann et al. which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Published patent applications, all of which are incorporated in their entirety by reference hereto: U.S. 2005/0222256; 2005/0265930.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming agents included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropol alcohol, iso-amylalcohol, benzyl alcohol, or a combination thereof.

In an embodiment, tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (piper nigrum), including the active ingredients chavicine and piperine; Echinacea extract; Northern Prickly Ash extract; trans-pellitorin, and red pepper oleoresin; or a combination thereof. In an embodiment, alkylamides extracted from materials such as jambu or sanshool may be included. Additionally, in an embodiment, a sensation is created due to effervescence. Such effervescence is created by combining an alkaline material with an acidic material, either or both of which may be encapsulated. In an embodiment, an alkaline material may include alkali metal carbonates, alkali metal bicarbonates, alkaline earth metal carbonates, alkaline earth metal bicarbonates or a combination thereof. In an embodiment, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid or a combination thereof. Examples of “tingling” type sensates include those disclosed in U.S. Pat. Nos. 6,780,443, 6,159,509, 5,545,424, and 5,407,665, each of which is incorporated by reference herein in its entirety.

The chewing gum composition may optionally further comprise a flavor modulator or potentiator. A sweet taste can come from flavor modulators or potentiators and/or from flavorants as well as from sweeteners. Flavor potentiators can consist of materials that intensify, supplement, modify or enhance the taste or aroma perception of an original material without introducing a characteristic taste or aroma perception of their own. Flavor modulators can impart a characteristic of their own that complements or negates a characteristic of another component. In an embodiment, flavor modulators or potentiators are designed to intensify, supplement, modify, or enhance the perception of flavor, sweetness, tartness, umami, kokumi, saltiness or a combination thereof can be included. Thus, the addition of flavor modulators or potentiators can impact the overall taste of the chewing gum. For example, flavors can be compounded to have additional sweet notes by the inclusion of flavor modulators or potentiators, such as vanilla, vanillin, ethyl maltol, furfual, ethyl propionate, lactones, or a combination thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), or a combination thereof. In an embodiment, sugar acids, sodium chloride, potassium chloride, sodium acid sulfate, or a combination thereof are used. In an embodiment, glutamates such as monosodium glutamate, monopotassium glutamate, hydrolyzed vegetable protein, hydrolyzed animal protein, yeast extract, or a combination thereof are included. Further examples include adenosine monophosphate (AMP), glutathione, and nucleotides such as inosine monophosphate, disodium inosinate, xanthosine monophosphate, guanylate monophosphate, or a combination thereof. Further examples of flavor potentiator compositions that impart kokumi are also included in U.S. Pat. No. 5,679,397 to Kuroda et al.

The amount of flavor modulators, flavor potentiators, and flavorants used herein can be a matter of preference subject to such factors as the type of final product composition, the individual flavor, and the strength of flavor desired. Thus, the amount of flavoring can be varied in order to obtain the result desired in the final product and such variations are within the capabilities of those skilled in the art without the need for undue experimentation.

Exemplary functional ingredients for optional use in the chewing gum composition include a breath freshener, a dental care component, an active agent, an herbal, an effervescing system, an appetite suppressor, a vitamin, a micronutrient, a mouth moistening component, a throat care component, an energy boosting agent, a concentration boosting agent, or a combination thereof.

The chewing gum composition may optionally further comprise a coloring agent. Coloring agents (colors, colorants, colorings) can be used in amounts effective to produce a desired color for the chewing gum. Suitable coloring agents include pigments, which can be incorporated in amounts up to about 6 wt % based on the total weight of the chewing gum. For example, titanium dioxide can be incorporated in amounts up to about 2 wt %, and specifically less than about 1 wt % based on the total weight of the chewing gum. Suitable coloring agents also include natural food colors and dyes suitable for food, drug, and cosmetic applications. Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494, which text is incorporated herein by reference.

The chewing gum composition may optionally further comprise a humectant. Exemplary humectants include glycerin, propylene glycol, polyethylene glycol, or a combination thereof. The amount of humectant can be controlled to ensure the final chewing gum product does not unduly absorb moisture from the surrounding environment during production, packaging, storage, and use.

The chewing gum composition may optionally further comprise an emulsifier, such as the emulsifiers described herein for use in the gum base.

### Gum Base

The chewing gum composition comprises a chewing gum base. The type of chewing gum base can be selected to increase the perception of the inclusions when the chewing gum product is chewed. For example, the chewing gum base can be made softer by use of increased amounts of softeners or plasticizers as disclosed below.

As used herein, the term “gum base” refers to water insoluble material(s) and can include, but is not limited to, elastomers, resins, waxes, elastomer solvents, emulsifiers, plasticizers, bulking agents/fillers, or a combination thereof.

In an embodiment, the chewing gum composition comprises a gum base comprising an elastomer and optionally an additional gum base ingredient, wherein the additional gum base ingredient is a resin, a fat, an emulsifier, a wax, a filler, a softener, a plasticizer, an antioxidant, or a combination thereof.

The amount of gum base employed will vary greatly depending upon various factors such as the type of base used, the consistency of the chewing gum composition desired, and the other components used in the composition to make the final chewing gum product. In general, the gum base will be present in amounts of about 5 to about 60 wt % based on the total weight of the chewing gum composition, specifically about 15 to about 50 wt %, more specifically about 25 to about 40 wt %, and yet more specifically about 30 to about 35 wt %.

Exemplary elastomers to be used in the chewing gum base include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, or a combination thereof. Synthetic elastomers such as butadiene-styrene copolymers, polyisobutylene, isobutyleneisoprene copolymers, polyethylene, a combination thereof, and the like, or a combination thereof are also useful. The gum base can include a non-toxic vinyl polymer, such as polyvinyl acetate and its partial hydrolysate, polyvinyl alcohol, or a combination thereof. When utilized, the molecular weight of the vinyl polymer can range from about 3,000 up to and including about 94,000. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate, or a combination thereof.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerin, or a combination thereof. Some of these ingredients may be added at the time of gum base formation or added later during the production of the chewing gum composition.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like, or a combination thereof, can also be incorporated into the gum base to obtain a variety of desirable textures and consistency properties.

When a wax is present in the gum base, it softens the polymeric elastomer mixture and improves the elasticity of the gum base. The waxes employed may have a melting point below about 60° C., and specifically between about 45° C. and about 55° C. The low melting wax can be a paraffin wax. The wax can be present in the gum base in an amount of about 0.1 to about 10 wt %, and specifically about 3 to about 7 wt % based on the total weight of the gum base.

In addition to the low melting point waxes, waxes having a higher melting point can be used in the gum base in amounts up to about 5 wt % based on the total weight of the gum base. Such high melting waxes include beeswax, vegetable wax, candelilla wax, carnuba wax, most petroleum waxes, and the like, or a combination thereof.

The chewing gum or gum base can optionally contain conventional elastomer solvents to aid in softening the elastomer base component, for example resins such as polymers of alpha-pinene or beta-pinene; methyl, glycerol or pentaerythritol esters of rosins or modified rosins and gums, such as hydrogenated, dimerized or polymerized rosins, or a combination thereof; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like; or a combination thereof. The elastomer solvent can be used in amounts of about 5 to about 75 wt % base on the total weight of the gum base, and specifically about 45 to about 70 wt %.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, or a combination thereof. These fillers or adjuvants can be used in the gum base in various amounts. Specifically the amount of filler, when used, can be present in an amount of greater than about 0 to about 60 wt % based on the total weight of the gum base, and more specifically from about 20 to about 30 wt %.

Suitable emulsifiers for use in the gum base include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate, lecithin, ammonium phosphatide, sucrose esters of fatty acids, sucroglycerides, propane-1,2-diol esters of fatty acids, or a combination thereof.

### Hard, Amorphous Inclusions

The hard, amorphous inclusions (also referred to as glassy inclusions) can be made from a sugar-based or sugar-free composition. Suitable sugar-based material for use to prepare the composition includes, for example, saccharides including mono-saccharides, di-saccharides and poly-saccharides. Exemplary saccharides include sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

Exemplary sugar-free materials that can be used to prepare the inclusions include a sugar alcohol, such as erythritol, galactitol, isomalt, a hydrogenated starch hydrolyzate, lactitol, maltitol, mannitol, polyglycitol, sorbitol, xylitol, and the like, or a combination thereof. The sugar alcohol used to prepare the inclusions can originally be in powdered or particulate form (either crystalline or amorphous) or in syrup form (also referred to as “solution”) with water. Exemplary sugar alcohol syrups include sorbitol syrup, maltitol syrup, hydrogenated starch hydrolysate syrup, polyglycitol syrup, and the like.

Suitable hydrogenated starch hydrolysates include those disclosed in U.S. Pat. No. 4,279,931 and various hydrogenated glucose syrups and/or powders that contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a line of commercially available products manufactured by Roquette Freres of France, and HYSTAR™, a line of commercially available products manufactured by Lonza, Inc., of Fairlawn, N.J., also can be useful.

The amount of saccharide or sugar alcohol in the inclusions composition can be about 90 to about 100 wt % based on the total weight of the inclusions composition, specifically about 92 to about 99 wt %, more specifically about 93 to about 98 wt %, yet more specifically about 94 to about 97 wt %, and yet more specifically about 95 to about 96 wt %.

The inclusions composition may further comprise an additional inclusions composition ingredient such as a flavorant, a food acid or salt thereof, a high intensity sweetener, a sensate, a flavor modulator or potentiator, a coloring agent, a functional ingredient, an emulsifier, or a combination thereof.

Exemplary flavorants that can be used in the inclusions composition include those previously mentioned for use in the chewing gum composition. The flavorant is present in the inclusions composition in an amount of 0 to about 2.5 wt % based on the total weight of the inclusions composition, specifically about 0.1 to about 2.0 wt %, more specifically about 0.5 to about 1.5 wt %, and yet more specifically about 0.75 to about 1.0 wt %.

Exemplary food acids or salt thereof that can be used in the inclusions composition include those previously mentioned for use in the chewing gum composition. The food acid or salt thereof is present in the inclusions composition in an amount of 0 to about 2.5 wt % based on the total weight of the inclusions composition, specifically about 0.1 to about 2.0 wt %, more specifically about 0.5 to about 1.5 wt %, and yet more specifically about 0.75 to about 1.0 wt %.

Exemplary high intensity sweeteners that can be used in the inclusions composition include those previously mentioned for use in the chewing gum composition. The high intensity sweetener is present in the inclusions composition in an amount of 0 to about 0.5 wt % based on the total weight of the inclusions composition, specifically about 0.001 to about 0.3 wt %, more specifically about 0.01 to about 0.2 wt %, and yet more specifically about 0.05 to about 0.1 wt %.

Exemplary sensates that can be used in the inclusions composition include those previously mentioned for use in the chewing gum composition. The sensate is present in the inclusions composition in an amount of 0 to about 0.5 wt % based on the total weight of the inclusions composition, specifically about 0.001 to about 0.3 wt %, more specifically about 0.01 to about 0.2 wt %, and yet more specifically about 0.05 to about 0.1 wt %.

Exemplary flavor modulator or potentiator, coloring agent, and functional ingredient that can be used in the inclusions composition include those previously mentioned for use in the chewing gum composition.

The inclusions composition can optionally further include an emulsifier to aid in the manufacturing process. Exemplary emulsifiers include diactyl tartaric acid esters of monoglycerides such as PANODAN (registered trademark of Danisco), lecithin, glycerol monostearate and glycerol mono-oleate or one of the other emulsifiers described herein.

The hard, amorphous inclusions phase can be prepared using known techniques in the art for preparing hard boiled candy. Alternatively, the amorphous inclusions can be prepared by melting the desired saccharide or sugar polyol and adding any additional inclusions ingredient with mixing and then allowing the melt to cool to a hard, amorphous glassy solid.

Preparation of the hard, amorphous inclusions phase can involve mixing and heating the saccharide, sugar alcohol or a combination thereof, with water, to form a melt; cooking the melt; removing excess moisture from the melt; cooling the melt with mixing until the melt is a plastic-like, workable mass; while the melt is a plastic-like mass, incorporating remaining additional ingredients; and forming the plastic-like mixture into hard, amorphous inclusions.

The hard, amorphous inclusions can be prepared using conventional methods and equipment, such as fire cookers, vacuum cookers, or scraped-surface cookers (also referred to as high speed atmospheric cookers). When using a fire cooker, the desired quantity of the saccharide or sugar alcohol is dissolved in water by heating the agent in a kettle until it dissolves. Additional saccharide or sugar alcohol can then be added and cooking continued until a final temperature of, for example, about 145° C. to about 156° C. is achieved. The batch is then cooled and worked as a plastic-like hard confectionary mass to incorporate additional ingredients separately or in the form of one or more concentrates.

In vacuum cookers, a saccharide or sugar alcohol is boiled to about 125° to about 165° C., vacuum is applied, and additional water is boiled off without extra heating. When cooking is complete, the mass is a semi-solid and has a plastic-like consistency. At this point, additional ingredients, separately or in the form of one or more concentrates are admixed in the mass by routine mechanical mixing operations.

A high-speed atmospheric cooker uses a heat exchanger surface. A film of a hard amorphous candy is spread on a heat exchange surface, rapidly heated to a suitable temperature, for example 165° to 170° C., and then rapidly cooled, for example to 100° to 120° C. Additional ingredients, separately or in the form of one or more concentrates can then be worked into the plastic-like mass.

In the foregoing methods, the additional ingredients, e.g., flavorants, colorants, and any other additive(s), are mixed in the mass for a time effective to obtain a uniform distribution of the materials. For example, mixing times from about 10 seconds to about 10 minutes have been found to be effective. Once the mass has been properly tempered, it can be formed into the desired shapes using one or more of a variety of forming techniques depending upon the shape and size of the final product desired.

The amorphous inclusions has a moisture content of about 0.5 to about 3.0 wt %, specifically about 1.0 to about 2.0 wt % based on the total weight of the amorphous inclusions.

The hard, amorphous inclusions can be prepared by grinding solidified hard, amorphous phase and sieving to obtain the desired particle size distribution. Grinding can be achieved using equipment and techniques known in the art. The particle size distribution of the inclusions can be determined using any techniques known in the art. One method of determining the particle size distribution is by a sieving technique. In an embodiment, a dry sieving method was used for the analysis of particle size distribution. A representative sample was taken by means of a sample divider. A known quantity of the sample was then sieved, with the aid of a sieve shaker set at defined parameters and through sieves of defined size (75, 150, 250, 355, 710, 1000 micrometer). After a defined time, the amount of sample remaining on each sieve was determined and the residue was reported in grams/100 grams or percentage.

In an embodiment, when larger particle sizes are used, the inclusions can have a size of about 1 to about 2 millimeters as measured by sieve analysis. In an embodiment, the inclusions can have a particle size distribution of less than 5, specifically less than 2.5, and more specifically less than 1 wt % retained on a 75 micrometer, a 150 micrometer, a 250 micrometer, or a 355 micrometer sieve; about 10 to about 30 wt %, specifically about 15 to about 25 wt % retained on a 710 micrometer sieve; and about 70 to about 90 wt %, specifically about 75 to about 85 wt % retained on a 1000 micrometer sieve.

In an embodiment, when smaller particle sizes are used, the inclusions can have a size of about 400 to about 600 micrometers, specifically about 500 micrometers, as measured by sieve analysis. In an embodiment, the inclusions can have a particle size distribution of less than 5, specifically less than 2.5, and more specifically less than 1 wt % retained on a 1000 micrometer sieve; about 10 to about 30 wt %, specifically about 15 to about 25 wt % retained on a 710 micrometer sieve; about 30 to about 55 wt %, specifically about 35 to about 50 wt % retained on a 355 micrometer sieve; about 5 to about 20 wt %, specifically about 10 to about 15 wt % retained on a 250 micrometer sieve; and about 5 to about 20 wt %, specifically about 10 to about 15 wt % retained on a 150 micrometer sieve.

In an embodiment, about 10 to about 90 wt %, specifically about 30 to about 70 wt % of the inclusions have a size of about 400 to about 600 micrometers, specifically about 500 micrometers and about 90 to about 10 wt %, specifically about 70 to about 30 wt % of the inclusions have a size of about 1 to about 2 millimeters, as measured by sieve analysis. In another embodiment, the inclusions have a particle size distribution of about 25 to about 38 wt %, specifically about 28 to about 35 wt % retained on a 1000 micrometer sieve; about 12 to about 25 wt %, specifically about 15 to about 22 wt % retained on a 710 micrometer sieve; about 18 to about 32 wt %, specifically about 20 to about 30 wt % retained on a 355 micrometer sieve; about 4 to about 11 wt %, specifically about 6 to about 9 wt % retained on a 250 micrometer sieve; and about 5 to about 11 wt %, specifically about 7 to about 9 wt % retained on a 150 micrometer sieve.

In an embodiment, the hard, amorphous inclusions do not have a uniform shape.

In an embodiment, the hard, amorphous inclusions contain a nasal passage clearing amount of menthol and/or eucalyptus oil.

### Chewing Gum Product

The inclusions are present in the chewing gum product in an amount of about 1 to about 35 wt % based on the total weight of the chewing gum product, specifically about 5 to about 30 wt %, more specifically about 10 to about 25 wt %, and still more specifically about 15 to about 20 wt %.

The inclusions can be sugar-based or sugar-free, specifically sugar-free.

The inclusions can be colored or uncolored, specifically having a color/color intensity different than the color of the chewing gum composition.

### Methods of Making the Chewing Gum Composition and Chewing Gum Product

The chewing gum composition can be prepared using standard techniques and equipment known in the art. In an embodiment, a method of making a chewing gum product comprises forming a chewing gum composition matrix comprising a gum base and a sugar alcohol bulk sweetener; and mixing a plurality of hard, amorphous inclusions with the chewing gum composition matrix to distribute the inclusions throughout the chewing gum composition matrix. In a further embodiment, the inclusions have a particle size of about 50 micrometer to about 2 millimeters.

In one exemplary process, a gum base is heated to a temperature sufficiently high to soften the gum base without adversely affecting the physical and chemical make up of the gum base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the gum base such as the plasticizer, fillers, and softener to plasticize the blend as well as to modulate the hardness, viscoelasticity and formability of the base. The chewing gum ingredients are next blended with the molten gum base. Mixing is continued until a uniform or homogeneous mixture of the chewing gum composition is obtained. Thereafter the chewing gum composition is blended with the inclusions to form a chewing gum blend that is formed into a chewing gum product, such as by extrusion followed by rolling and scoring.

In another exemplary process, chewing gum ingredients are mixed with gum base without prior melting of the gum base or gum base ingredients. Mixing is continued until a uniform or homogeneous mixture of the chewing gum composition is obtained. Thereafter the chewing gum composition can be blended with the inclusions. Within this embodiment, the gum base can be in the form of a pelletized gum base that can be softened at 40 to 50° C. rather than melting at higher temperatures.

In another embodiment, a combination of melted gum base and pelletized gum base can be used.

The chewing gum composition can be prepared using a batch method or a continuous method or a combination thereof.

The processing equipment used to prepare the chewing gum composition can be monitored and/or controlled automatically. For example, the processing equipment can be coupled to a computerized system which allows the user to input certain and/or all of the operational parameters, including, e.g., feeding of the ingredients, mixing or processing the ingredients, conveying the ingredients. In an embodiment, the system can be coupled to batch processing equipment, continuous processing equipment, or both if both types are used. In an embodiment, changing the input parameters used to control the processing can create changes in the final composition, e.g., ingredient amount and type, etc. For example, the ingredient and/or processing temperatures and/or feed rates of the ingredients can be monitored and fed back to a central unit so that the operator can adjust as needed and/or in which the system can automatically adjust. After the ingredients have been mixed, the formation, processing into a particular shape and/or form can also be monitored and fed back for the operators input and/or automatic adjustment. An audible and/or visual alarm can also be implemented to signal the operator when the system detects a problem and/or a variation in one or more processing parameters.

The chewing gum composition can be formed into a chewing gum product using a variety of processes including an extrusion process, a coextrusion process, a triple extrusion process, a laminate process, a molding process, a compression process, a rolling and scoring process, a chain die process, or a rotary die process.

The chewing gum product can be prepared in any shape including a slab, stick, pellet, chunk, and the like, specifically a slab or stick shape.

In an embodiment, the chewing gum product can be coated. In a specific embodiment, the chewing gum product is an uncoated slab or stick allowing the inclusions to be perceived visually by the consumer.

The chewing gum product comprising a homogeneous mixture of chewing gum composition and distributed hard, amorphous inclusions is not a product containing layers (e.g. laminated) of hardboiled candy and chewing gum. The chewing gum product with inclusions is visually different from the laminated concept and provides a different sensory experience. It does not provide a crisp “honey-combed” chewing gum. Rather the inclusions provide a product having a more obvious and longer lasting crunch.

In an embodiment, the chewing gum composition and the chewing gum product are not prepared from particulate chewing gum.

The use of the hard, amorphous inclusions provides the chewing gum product with a smooth crunch that when chewed is different to the gritty crunch provided by crystalline material (polyol crystals/crystal melts) or the burst of liquid capsules.

### Sensory Analysis

Descriptive analysis is a sensory method by which the sensory attributes of a food or product are identified and quantified, using human subjects who have been specifically chosen and trained for this purpose. Once trained, a panel of evaluators will function as a human analytical instrument, generating reproducible values, rather than degrees of liking or dislike as in consumer panels.

The chewing gum products containing hard, amorphous inclusions exhibit improved mouthfeel, crunchiness, flavor release, and sound in comparison to other chewing gum products when evaluated using a panel trained in the principles of quantitative descriptive analysis (QDA), such as those described by Stone & Sidel (Stone & Sidel, Sensory Evaluation Practices, 3rd ed. San Diego, Calif. Elsevier Academic Press (2004)).

In an embodiment, a chewing gum product comprises a chewing gum composition matrix comprising a gum base and a sugar alcohol bulk sweetener; and a plurality of hard, amorphous inclusions distributed throughout the chewing gum composition matrix, wherein the chewing gum product comprising the hard, amorphous inclusions has a flavor impression rating upon initial chewing that is at least 10, specifically about 10 to about 25 points greater than a flavor impression rating of a chewing gum without the hard, amorphous inclusions based on a scale of 0 to 100 as measured by descriptive analysis using the Quantitative Descriptive Analysis method.

In an embodiment, a chewing gum product comprises a chewing gum composition matrix comprising a gum base and a sugar alcohol bulk sweetener; and a plurality of hard, amorphous inclusions distributed throughout the chewing gum composition matrix, wherein the chewing gum product comprising the hard, amorphous inclusions has a flavor impression rating at 2 or 4 minutes from the start of chewing that is at least 10, specifically about 10 to about 20, and more specifically about 10 to about 15 points greater than a flavor impression rating of a chewing gum without the hard, amorphous inclusions based on a scale of 0 to 100 as measured by descriptive analysis using the Quantitative Descriptive Analysis method.

In an embodiment, a chewing gum product comprises a chewing gum composition matrix comprising a gum base and a sugar alcohol bulk sweetener; and a plurality of hard, amorphous inclusions distributed throughout the chewing gum composition matrix, wherein the chewing gum product comprising the hard, amorphous inclusions has a crunchy noise impression rating upon initial chewing that is at least 5 points greater than a crunchy noise impression rating of a chewing gum without the hard, amorphous inclusions based on a scale of 0 to 100 as measured by descriptive analysis using the Quantitative Descriptive Analysis method.

The features and advantages are more fully shown by the following examples which are provided for purposes of illustration, and are not to be construed as limiting the invention in any way.

### EXAMPLES

### Example 1

### Hard, Amorphous Inclusions—Sugar Free Candy

The hard, amorphous candy inclusions are prepared by cooking a sugar alcohol and water to the hard boil stage (moisture content of below about 4 wt %). Alternatively, the sugar alcohol can be melted to a molten state without first combining with water. The molten sugar alcohol is cooled slightly and mixed with flavorants, colorants, high intensity sweeteners, or other additional candy ingredients. The final mixture is cooled to a hard glassy state and ground to desired particle size using grinding or milling equipment known in the art. The ground hard, amorphous candy can be obtained in a select particle size distribution using known techniques in the art such as sieving and the like. Formulations for the hard, amorphous candy inclusions are provided in Table 1.

TABLE 1
Hard, amorphous mint and fruit inclusion formulations

| | A | B | C | D | E | F |
|---|---|---|---|---|---|---|
| Ingredient | weight % | | | | | |
| Isomalt | 98.877 | — | 69.214 | 98.877 | — | 69.214 |
| Maltitol | — | 98.877 | 29.663 | — | 98.877 | 29.663 |
| High intensity sweetener (e.g. | 0.065 | 0.065 | 0.065 | 0.065 | 0.065 | 0.065 |
| Acesulfame-K, sucralose, etc.) | | | | | | |
| Mint flavorant | 0.2 | 0.2 | 0.2 | — | — | — |
| Fruit flavorant | — | — | — | 0.2 | 0.2 | 0.2 |
| Food acid (e.g. citric acid, malic | — | — | — | 0-0.75 | 0-0.75 | 0-0.75 |
| acid, etc.) | | | | | | |
| Menthol | 0.75 | 0.73 | 0.75 | — | — | — |
| Physiological cooling agent | — | 0.02 | — | — | — | — |
| (e.g. WS-3, WS-23, WS-5, etc.) | | | | | | |
| Water | 0.1 | 0.1 | 0.1 | 0.1 | 0.1 | 0.1 |
| Colorant | 0.008 | 0.008 | 0.008 | 0.008 | 0.008 | 0.008 |
| Total | 100 | 100 | 100 | 100 | 100 | 100 |

Inclusion size: The particle size of the inclusions can be determined using a sieving technique. Larger inclusions had a particle size of about 1 to about 2 millimeters and smaller inclusions had a particle size of about 400 to about 600 micrometers, both as measured by sieve analysis.

Formulations for the chewing gum compositions are provided in Table 2.

TABLE 2
Chewing gum formulations

| | A | B | C | D | E | F |
|---|---|---|---|---|---|---|
| Ingredient | weight % | | | | | |
| Gum base | 25-35 | 25-35 | 25-35 | 25-35 | 25-35 | 25-35 |
| Maltitol (syrup) | 0-5 | 0-5 | 0-5 | 0-5 | 0-5 | 0-5 |
| Lecithin | 0-0.5 | 0-0.5 | 0-0.5 | 0-0.5 | 0-0.5 | 0-0.5 |
| Glycerin | 0-4 | 0-4 | 0-4 | 0-4 | 0-4 | 0-4 |
| Sorbitol (powder) | 40-50 | — | 40-50 | 40-50 | — | 40-50 |
| Mannitol (powder) | — | 40-50 | 8-15 | — | 40-50 | 8-15 |
| Maltitol (powder) | 8-15 | — | — | 8-15 | — | — |
| Xylitol (powder) | — | 2-10 | — | — | 2-10 | — |
| High intensity sweetener (e.g. | 0-0.5 | 0-0.5 | 0-0.5 | 0-0.5 | 0-0.5 | 0-0.5 |
| Acesulfame-K, sucralose, etc.) | | | | | | |
| Encapsulated high intensity | 0.5-1.5 | 0.5-1.5 | 0.5-1.5 | 0.5-1.5 | 0.5-1.5 | 0.5-1.5 |
| sweetener | | | | | | |
| Mint flavorant | 0.01-2.5 | 0.01-2.5 | 0.01-2.5 | — | — | — |
| Fruit flavorant | — | — | — | 0.01-2.5 | 0.01-2.5 | 0.01-2.5 |
| Food acid (e.g. citric acid, malic | — | — | — | 0-0.75 | 0-0.75 | 0-0.75 |
| acid, etc.) | | | | | | |
| Physiological cooling agent | 0-0.03 | 0-0.03 | 0-0.03 | 0-0.03 | 0-0.03 | 0-0.03 |
| (e.g. WS-3, WS-23, WS-5, etc.) | | | | | | |
| Water | 0-0.05 | 0-0.05 | 0-0.05 | 0-0.05 | 0-0.05 | 0-0.05 |
| Colorant | 0-0.5 | 0-0.5 | 0-0.5 | 0-0.5 | 0-0.5 | 0-0.5 |
| Total | 100 | 100 | 100 | 100 | 100 | 100 |

The chewing gum was prepared by melting the gum base using techniques and equipment known in the art. The sugar alcohol bulk sweetener, maltitol syrup, lecithin, and glycerin are added to the molten gum base with mixing. If used, the flavorant, cooling compounds, colorant, and food acid are added with mixing followed by the addition of high intensity sweeteners to form a chewing gum composition.

The chewing gum matrix blend with hard, amorphous inclusions is prepared by homogeneously mixing the inclusions selected from a formulation in Table 1 with a chewing gum composition selected from a formulation in Table 2. in an exemplary weight ratio of about 15-20 wt % inclusions to 85-80 wt % chewing gum composition. Depending upon the desired texture and chew properties of the final chewing gum product and taking into account the particle size of the inclusions, different amounts of inclusions can be used. For example, larger sized inclusions (about 1 to about 2 millimeters) can be used in an amount of about 15 wt % while the smaller sized inclusions (about 400 to about 600 micrometers) can be used in an amount of about 20 wt %, based on the total weight of the chewing gum product.

The resulting chewing gum blend containing inclusions can be carefully formed into pieces using techniques and equipment known in the chewing gum art, e.g. extrusion and rolling and scoring to form slab products.

### Example 2

### Sensory Evaluation

Four samples were evaluated a 20 minute chew assessment by a trained panel using Quantitative Descriptive Analysis (QDA). The same uncolored, mint flavored chewing gum formulation was used for each sample, varying only the type and amount of inclusion material while keeping the recipe components as constant and comparable as possible for fair technologies comparison. The samples are set out in Table 3.

TABLE 3

| | Inclusion and amount based on total weight |
|---|---|
| Sample | of the chewing gum formulation |
| A | 15 wt % larger (about 1 to about 2 millimeters) |
| | hard, amorphous glassy inclusions, blue |
| B | 20 wt % smaller (about 400 to about 600 micrometers) |
| | hard, amorphous glassy inclusions, blue |
| C | 5 wt % isomalt crystals, uncolored (isomalt ST CGS) |
| | with a particle size specification around 900 micrometers |
| D | 2 wt % Liquid flavor capsules, gelatin capsules |
| | containing liquid flavor |

Methodology: The samples were evaluated by a panel of trained sensory assessors. The vocabulary was generated via a 2-hour language development session. Eleven QDA panelists evaluated three samples per session. The samples were assessed for flavor at times initial, 2 minutes, 4 minutes, 6.5 minutes, 9 minutes, 14 minutes, 19 minutes, and after taste; initial hardness texture; size of grit at initial; crunchy noise at time initial; gritty texture at time initial and 2 minutes; and smooth texture at times initial, 2 minutes, 4 minutes, 6.5 minutes, 9 minutes, 14 minutes, 19 minutes. The order of sample presentation was randomized across assessors. Serving size: one piece. Length of chew: 20 minutes. All attributes were rated on an unstructured line scale, then electronically quantified on a 100-point scale. Results were collected via the SIMS (Sensory Information Management System) and were analyzed with Tragon QDA® software using analysis of variance (ANOVA). The Duncan minimum significant difference was calculated in order to determine for each attribute, those samples, which were significantly different (p<0.05).

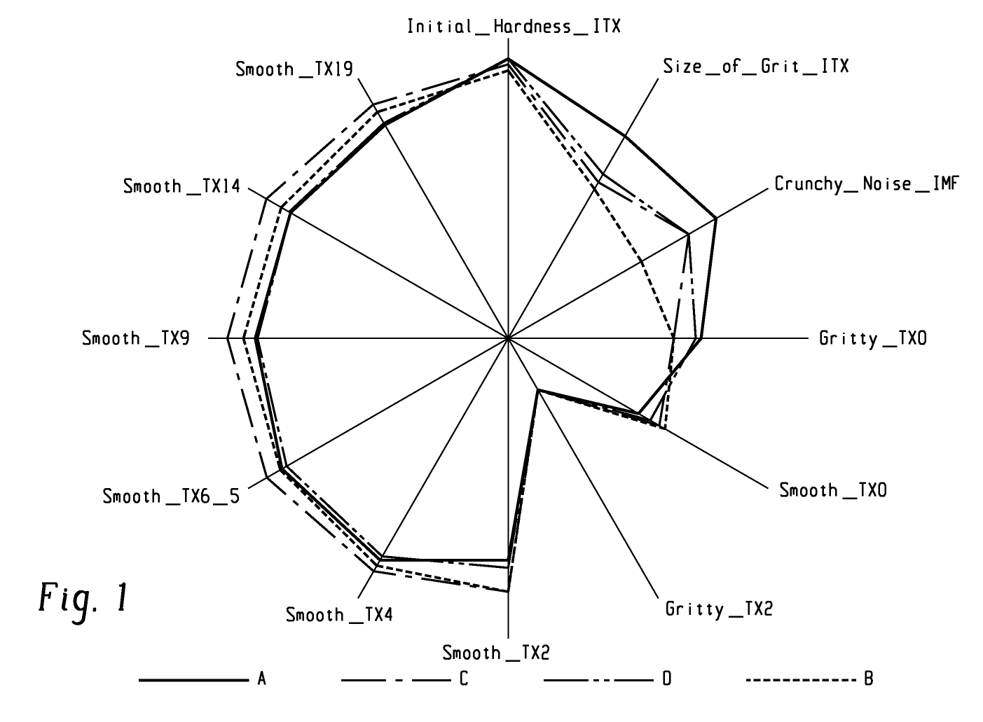

Tables 4. and 5. provide the texture and mouthfeel results of the QDA study and the data is graphically illustrated in FIG. 1.

TABLE 4

| Sample | Initial_Hardness_ITX | Size_of_Grit_ITX* | Crunchy_Noise_IMF* | Gritty_TX0 | Smooth_TX0 | Gritty_TX2 |
|---|---|---|---|---|---|---|
| A | 72.98 | 60.18 | 61.84 | 49.93 | 39.2 | 15.73 |
| C | 72.32 | 46.95 | 53.86 | 43.07 | 46.48 | 15.48 |
| D | 72.61 | 48.84 | 54.02 | 48.57 | 43.18 | 17.48 |
| B | 69.59 | 45 | 39.64 | 42.5 | 46.61 | 15.3 |

*Significant differences at 95% confidence level

TABLE 5

| Sample | Smooth_TX2* | Smooth_TX4* | Smooth_TX6_5* | Smooth_TX9* | Smooth_TX14* | Smooth _ TX19* |
|---|---|---|---|---|---|---|
| A | 56.77 | 66 | 66.82 | 65.75 | 64.89 | 63.86 |
| C | 66.82 | 70.14 | 71.82 | 72.8 | 72.39 | 69.61 |
| D | 59.41 | 63.93 | 65.61 | 66.07 | 65.2 | 64.36 |
| B | 66.09 | 68.57 | 68.5 | 68.86 | 67.5 | 67.48 |

*Significant differences at 95% confidence level

Texture and Mouthfeel: The product with the hard, amorphous candy inclusions (A) delivered increased initial feeling on the tongue providing a unique experience not provided by the comparative inclusions. The product with the hard, amorphous candy inclusions (A) was rated as the most crunchy overall.

Sound: The product with the hard, amorphous candy inclusions (A) delivered a significant louder (crunch) noise, which is perceived as a positive impact on perceived crunchiness of the product.

Flavor: The products with the hard, amorphous candy inclusions (A) and (B) delivered as much peppermint flavor burst as the comparative product containing pure flavor capsules (D). Each received >50 points for intensity of peppermint flavor on a 100 point scale at time: initial and after two minutes of chewing. The delivery of increased flavor was sustained for up to 14 minutes. The comparative example (C) with isomalt crystals did not provide an upfront and sustained burst of peppermint flavor, only receiving an initial and 2 minute intensity rating of about 30 out of 100. It is noted that the hard, amorphous candy inclusions provides a much better release of flavor than chewing gum without the inclusions. Furthermore, it provided as much peppermint impact as the liquid flavor capsules at half the cost. Not wishing to be bound by theory, but it is proposed that the initial burst of flavor is due to the amorphous phase of the inclusions where flavorant/cooling agent components are imbedded.

Visual: The use of the colored hard, amorphous candy inclusions in the chewing gum provided an interesting and appealing color contrast not provided by the plain isomalt crystals (C) or the capsules (D).

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list. The term “homogeneous” refers to a uniform blend of the components.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A chewing gum product, comprising:
a chewing gum composition matrix comprising a gum base and a sugar alcohol bulk sweetener; and
a plurality of hard, amorphous inclusions distributed throughout the chewing gum composition matrix, the inclusions having a particle size of about 50 micrometer to about 2 millimeters.

2. The chewing gum product of claim 1, wherein the inclusions have a particle size of about 1 to about 2 millimeters as measured by sieve analysis.

3. The chewing gum product of claim 1, wherein the inclusions have a particle size distribution of
less than 5 wt % retained on a 75 micrometer, a 150 micrometer, a 250 micrometer, or a 355 micrometer sieve;
about 10 to about 30 wt % retained on a 710 micrometer sieve; and
about 70 to about 90 wt % retained on a 1000 micrometer sieve.

4. The chewing gum product of claim 1, wherein the inclusions have a particle size distribution of
less than 5 wt % retained on a 75 micrometer, a 150 micrometer, a 250 micrometer, or a 355 micrometer sieve;
about 15 to about 25 wt % retained on a 710 micrometer sieve; and
about 75 to about 85 wt % retained on a 1000 micrometer sieve.

5. The chewing gum product of claim 1, wherein the inclusions have a particle size of about 400 to about 600 micrometers as measured by sieve analysis.

6. The chewing gum product of claim 1, wherein the inclusions have a particle size distribution of
less than 5 wt % retained on a 1000 micrometer sieve;
about 10 to about 30 wt % retained on a 710 micrometer sieve;
about 30 to about 55 wt % retained on a 355 micrometer sieve;
about 5 to about 20 wt % retained on a 250 micrometer sieve; and
about 5 to about 20 wt % retained on a 150 micrometer sieve.

7. The chewing gum product of claim 1, wherein the inclusions have a particle size distribution of
less than 5 wt % retained on a 1000 micrometer sieve;
about 15 to about 25 wt % retained on a 710 micrometer sieve;
about 35 to about 50 wt % retained on a 355 micrometer sieve;
about 10 to about 15 wt % retained on a 250 micrometer sieve; and
about 10 to about 15 wt % retained on a 150 micrometer sieve.

8. The chewing gum product of claim 1, wherein about 10 to about 90 wt % of the inclusions have a particle size of about 400 to about 600 micrometers as measured by sieve analysis and about 90 to about 10 wt % of the inclusions have a particle size of about 1 to about 2 millimeters, as measured by sieve analysis.

9. The chewing gum product of claim 1, wherein about 30 to about 70 wt % of the inclusions have a particle size of about 400 to about 600 micrometers as measured by sieve analysis and about 70 to about 30 wt % of the inclusions have a particle size of about 1 to about 2 millimeters, as measured by sieve analysis.

10. The chewing gum product of claim 1, wherein the inclusions have a particle size distribution of
about 25 to about 38 wt % retained on a 1000 micrometer sieve;
about 12 to about 25 wt % retained on a 710 micrometer sieve;
about 18 to about 32 wt % retained on a 355 micrometer sieve;
about 4 to about 11 wt % retained on a 250 micrometer sieve; and
about 5 to about 11 wt % retained on a 150 micrometer sieve.

11. The chewing gum product of claim 1, wherein the inclusions have a particle size distribution of
about 28 to about 35 wt % retained on a 1000 micrometer sieve;
about 15 to about 22 wt % retained on a 710 micrometer sieve;
about 20 to about 30 wt % retained on a 355 micrometer sieve;
about 6 to about 9 wt % retained on a 250 micrometer sieve; and
about 7 to about 9 wt % retained on a 150 micrometer sieve.

12. The chewing gum product of claim 1, comprising about 5 to about 35 wt % inclusions based on the total weight of the chewing gum product.

13. The chewing gum product of claim 1, comprising about 10 to about 30 wt % inclusions based on the total weight of the chewing gum product.

14. The chewing gum product of claim 1, comprising about 15 to about 25 wt % inclusions based on the total weight of the chewing gum product.

15. The chewing gum product of claim 1, wherein the chewing gum composition sugar alcohol bulk sweetener is erythritol, galactitol, isomalt, a hydrogenated starch hydrolyzate, lactitol, maltitol, mannitol, polyglycitol, sorbitol, xylitol, or a combination thereof

16. The chewing gum product of claim 1, wherein the chewing gum composition further comprises a flavorant, a food acid or salt thereof, a high intensity sweetener, a sensate, a flavor modulator or potentiator, a coloring agent, a functional ingredient, a humectant, an emulsifier, or a combination thereof.

17. The chewing gum product of claim 1, wherein the chewing gum composition comprises
about 15 to about 50 wt % gum base, and
about 30 to about 85 wt % sugar alcohol bulk sweetener, all weights based on the total weight of the chewing gum composition.

18. The chewing gum product of claim 1, wherein the chewing gum composition comprises
about 25 to about 40 wt % gum base, and
about 45 to about 75 wt % sugar alcohol bulk sweetener, all weights based on the total weight of the chewing gum composition.

19. The chewing gum product of claim 1, wherein the chewing gum composition comprises
about 30 to about 35 wt % gum base, and
about 55 to about 65 wt % sugar alcohol bulk sweetener, all weights based on the total weight of the chewing gum composition.

20. The chewing gum product of claim 1, wherein the plurality of hard, amorphous inclusions comprises a saccharide, a sugar alcohol, or a combination thereof.

21. The chewing gum product of claim 20, wherein the plurality of hard, amorphous inclusions further comprises a flavorant, a food acid or salt thereof, a high intensity sweetener, a sensate, a flavor modulator or potentiator, a coloring agent, a functional ingredient, an emulsifier, or a combination thereof.

22. The chewing gum product of claim 1, wherein the chewing gum composition matrix has a different colorant, a different flavorant, or a combination thereof than the hard, amorphous inclusions.

23. The chewing gum product of claim 1, wherein the chewing gum product comprising the hard, amorphous inclusions has a flavor impression rating upon initial chewing that is at least 10 points greater than a flavor impression rating of a chewing gum without the hard, amorphous inclusions based on a scale of 0 to 100 as measured by descriptive analysis using the Quantitative Descriptive Analysis method.

24. The chewing gum product of claim 1, wherein the chewing gum product comprising the hard, amorphous inclusions has a flavor impression rating at 2 minutes from the start of chewing that is at least 10 points greater than a flavor impression rating of a chewing gum without the hard, amorphous inclusions based on a scale of 0 to 100 as measured by descriptive analysis using the Quantitative Descriptive Analysis method.

25. The chewing gum product of claim 1, wherein the chewing gum product comprising the hard, amorphous inclusions has a crunchy noise impression rating upon initial chewing that is at least 5 points greater than a crunchy noise impression rating of a chewing gum without the hard, amorphous inclusions based on a scale of 0 to 100 as measured by descriptive analysis using the Quantitative Descriptive Analysis method.

26. A method of making a chewing gum product, comprising:
forming a chewing gum composition matrix comprising a gum base and a sugar alcohol bulk sweetener; and
mixing a plurality of hard, amorphous inclusions with the chewing gum composition matrix to distribute the inclusions throughout the chewing gum composition matrix.
